(19) United States
(12) Patent Application Publication
(10) Pub. No.: US 2026/0048977 A1
(43) Pub. Date: Feb. 19, 2026

(54) BEVERAGE DISPENSER FOR MIXING AND DISPENSING HOT AND COLD BEVERAGES

(71) Applicant: Micro Matic USA, INC., Brooksville, FL (US)

(72) Inventor: Joseph M. Lisiecki, Spring Hill, FL (US)

(73) Assignee: Micro Matic USA, INC., Brooksville, FL (US)

(21) Appl. No.: 19/215,104

(22) Filed: May 21, 2025

Related U.S. Application Data
(60) Provisional application No. 63/683,105, filed on Aug. 14, 2024.

(51) Int. Cl. B67D 3/00

(52) U.S. Cl. CPC B67D 3/0012; B67D 3/0009; B67D 3/0022; B67D 3/0077; B67D 2210/00013

(57) ABSTRACT

A beverage dispensing unit is provided. The beverage dispensing unit may include an upper cabinet configured to house a first plurality of beverage containers, a cold beverage chassis, a hot beverage chassis, and one or more user interfaces configured to receive a beverage request from a user, a lower cabinet configured to house a second plurality of beverage containers, a flash heater including a boiler configured to heat water and one or more beverage coils configured to be submerged in the hot water to heat one or more beverages respectively disposed in the beverage coils, a cold exchange unit containing a water tank and a second beverage coil contained within the water tank to chill a beverage contained with the beverage coil, and a flash chiller configured to chill water and circulate cold water to the cold exchange unit to fill the water tank.

### CROSS REFERENCE TO RELATED APPLICATIONS

The present application claims priority to U.S. Provisional Patent Application No. 63/683,105, entitled: Beverage Dispenser for Mixing and Dispensing Hot and Cold Beverages, filed on Aug. 14, 2024, the contents of which are hereby incorporated by reference in their entirety.

### FIELD

The present disclosure relates generally to beverage dispensers, and more specifically to beverage dispensers that are able to mix and dispense hot and cold beverages.

### SUMMARY

According to an aspect of one or more examples, there is provided a beverage dispensing unit. The beverage dispensing unit may include an upper cabinet configured to house a first plurality of beverage containers, a cold beverage chassis, a hot beverage chassis, and one or more user interfaces configured to receive a beverage request from a user, a lower cabinet configured to house a second plurality of beverage containers, a flash heater including a boiler configured to heat water and one or more beverage coils configured to be submerged in the hot water to heat one or more beverages respectively disposed in the beverage coils, a cold exchange unit containing a water tank and a second beverage coil contained within the water tank to chill a beverage contained with the beverage coil, and a flash chiller configured to chill water and circulate cold water to the cold exchange unit to fill the water tank. The hot and cold beverage chassis may be configured to receive and mix one or more base liquids, a plurality of flavor liquids, and a gas based on the beverage request from the user. The upper cabinet may include refrigerated compartments separated into hot and cold chassis cavities. The lower cabinet may include a bag-in-box (BIB) shelf configured to store milk, oat milk, and other liquid ingredients. The cold beverage chassis may include three mixing manifolds each configured to receive distinct liquid bases. Each mixing manifold may include at least one port for receiving a gas and another port for receiving water. Each actuator may be coupled to a dispense valve having a sanitize position and a dispense position. The beverage coils in the flash heater may be formed from stainless steel. The beverage output temperature may be controlled by varying the length and material of the beverage coils in the flash heater and exchanger modules. The beverage dispensing unit may include a multi-tube connector in the upper cabinet configured to consolidate beverage tubes from pumps to ingredient containers.

According to an aspect of one or more examples, there is provided a beverage dispensing system. The beverage dispensing system may include a control system coupled to a plurality of actuators, a memory storing beverage recipes, and a plurality of temperature control modules including a flash heater and a flash chiller. The control system may be configured to receive a user beverage request via a touch screen, determine a recipe based on the request, and control the dispensing of beverage ingredients via a hot or cold chassis accordingly. The hot chassis and cold chassis may each include multiple mixing manifolds, each configured to mix a base liquid, one or more flavoring liquids, and a gas to form a beverage. The control system may include a CAN bus configured to carry pre-programmed control signals for recipe creation and cleaning sequences. The memory may include recipes that are dynamically adjusted based on selected cup size and whether the beverage is to be served over ice. The beverage chassis may be removable via bulkhead connectors for service without detaching individual ingredient tubes. The flash heater may maintain a water level sufficient to submerge beverage coils and provide continuous hot beverage output. The flash chiller may maintain a layer of ice around a cold water tank to stabilize the temperature of beverages during dispensing.

According to an aspect of one or more examples, there is provided a method of dispensing a customized beverage using a beverage dispenser. The method may include receiving a beverage selection and customization input via a user interface, determining a recipe corresponding to the selected beverage including ingredient ratios and dispensing temperature, activating pumps to extract one or more base liquids and flavoring liquids from upper or lower beverage containers, mixing the ingredients in a hot or cold mixing manifold, adjusting gas infusion into the beverage based on the recipe, and dispensing the beverage via an actuator-controlled nozzle. Adjusting gas infusion may include regulating nitrogen infusion for cold brew coffee or other carbonated beverages. The method may include sanitizing the beverage path by actuating a sanitize mode or the dispensing valves to flow sanitizing solution through the manifolds. The determining step may include reducing amounts of other ingredients in response to a customization request for additional flavoring to avoid overflow. The user interface may present a visual indicator above the actuator corresponding to the ready-to-dispense beverage.

### BRIEF DESCRIPTION OF DRAWINGS

A more complete understanding of the present embodiments, and the attendant advantages and features thereof, will be more readily understood by reference to the following detailed description when considered in conjunction with the accompanying drawings wherein:

FIG. 1A illustrates a perspective view of a beverage dispenser for mixing and dispensing hot and cold beverages according to various examples.

FIG. 1B illustrates a perspective view of a beverage dispenser for mixing and dispensing hot and cold beverages according to various examples with two upper doors and one lower door open.

FIG. 1C illustrates an exploded view of an upper refrigerated cabinet according to various examples.

FIG. 1D shows a perspective view of an upper cabinet of a beverage dispenser for mixing and dispensing hot and cold beverages according to various examples.

FIG. 2A illustrates top and perspective views of a cold beverage chassis according to various examples.

FIG. 2B illustrates front and side views of a cold beverage chassis according to various examples.

FIG. 3A illustrates a top view of a hot beverage chassis according to various examples.

FIG. 3B illustrates a cross sectional view along line A-A of FIG. 3A and a perspective view of a hot beverage chassis according to various examples.

FIG. 3C illustrates a cross sectional view along line B-B of FIG. 3A and a bottom view of a hot beverage chassis according to various examples.

FIG. 4 shows a heat exchange module according to various examples.

FIG. 5 shows a perspective view of a cabinet insert assembly for a lower cabinet according to various examples.

FIG. 6 shows a container for holding beverage ingredients according to various examples.

FIG. 7 shows a component cabinet to be inserted into a commercial refrigerator according to various examples.

FIG. 8A shows a perspective internal view of a flash heater according to various examples.

FIG. 8B shows an enlarged view of several components of the flash heater shown in FIG. 8A.

FIG. 8C shows a rear view of a beverage dispenser according to various examples in which a flash heater is coupled to a lower cabinet.

FIG. 9 shows a beverage heat/cold exchanger according to various examples.

FIG. 10 shows a flowchart of a method for dispensing a customized beverage using a beverage dispenser according to various examples.

### DETAILED DESCRIPTION OF VARIOUS EXAMPLES

Reference will now be made in detail to the following various examples, which are illustrated in the accompanying drawings, wherein like reference numerals refer to like elements throughout. The following examples may be embodied in various forms without being limited to the examples set forth herein. Descriptions of well-known parts are omitted for clarity.

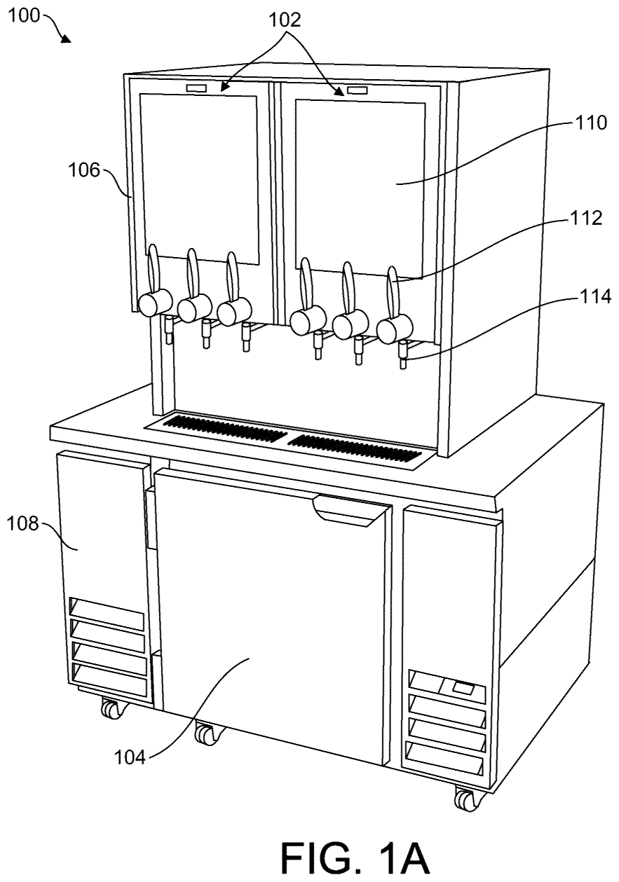

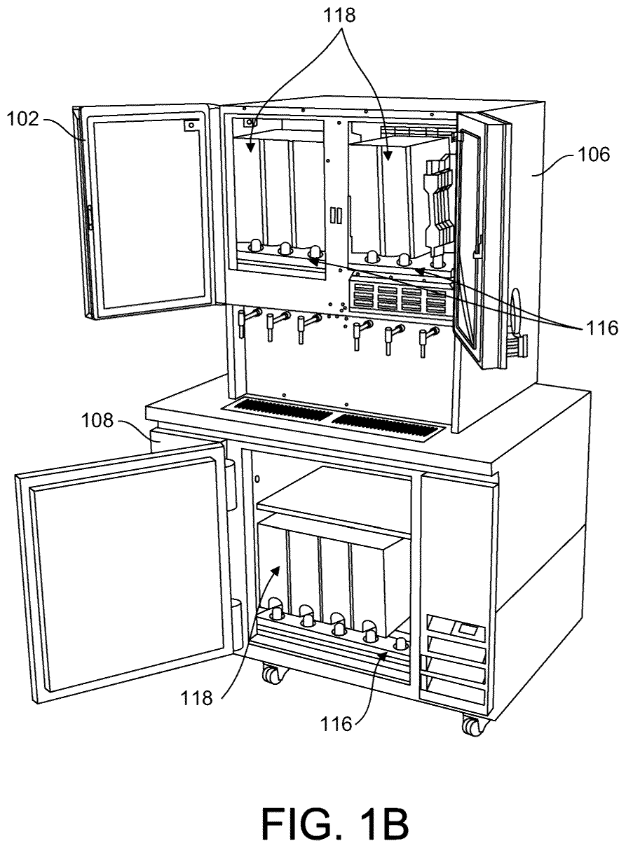

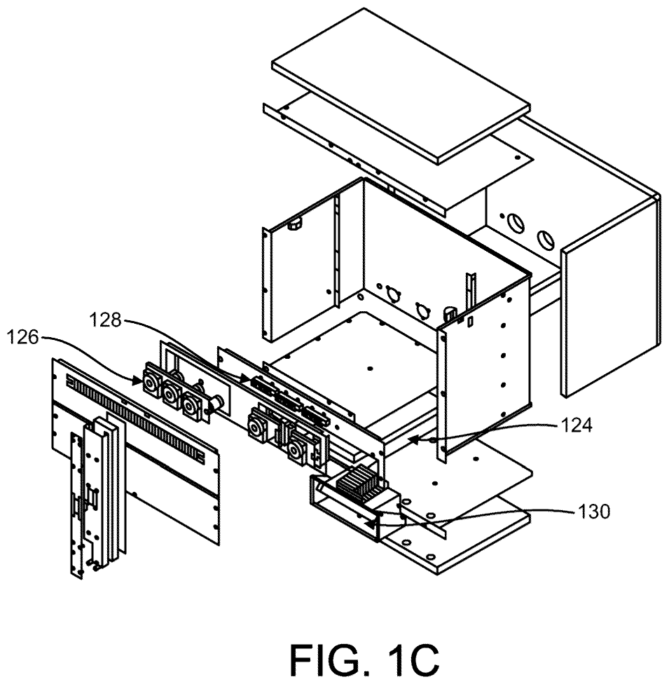

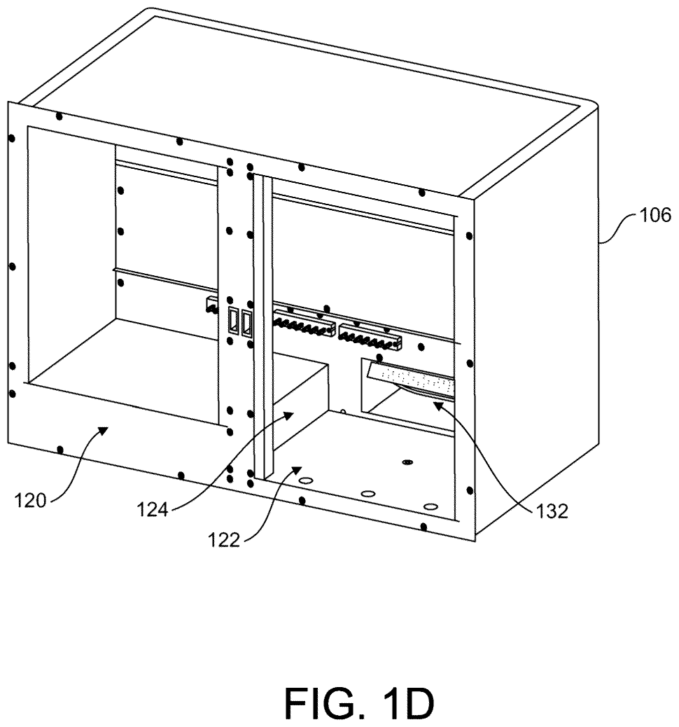

FIG. 1A illustrates a perspective view of a beverage dispenser 100 configured for mixing and dispensing hot and cold beverages according to various examples. FIG. 1B illustrates a similar perspective view of the beverage dispenser 100 with upper doors 102 and a lower door 104 in an open position. Referring to FIGS. 1A and 1B, the beverage dispensing and mixing device may include an upper cabinet 106 and a lower cabinet 108, each of which may contain one or more sub-assemblies, as described in more detail below. The upper cabinet 106 may include a pair of upper doors 102 that may be hingedly attached to a main body of the upper cabinet 106. The upper doors 102 may respectively include touch screens 110 and a plurality of actuators 112. The plurality of actuators 112 may control the dispensing of multiple beverages from corresponding nozzles 114, which may be mounted to the upper cabinet 106 below the upper doors 102.

The touch screens 110 may be coupled to a control system (not shown), which may include a voltage regulator to convert an input voltage to a voltage suitable for use by the control system. For example, the voltage regulator may convert a 115 V AC input voltage to a 24V DC voltage. The control system may also include processing circuitry, such as one or more central processing units (CPUs), microcontrollers, field programmable gate arrays (FPGAs), application specific integrated circuit (ASIC), and the like. According to various examples, each of the upper doors 102 may contain processing circuitry for controlling the respective touch screens 110. The control system may also include one or more wire harnesses to connect the processing circuitry to various devices such as pumps, electronic regulators, and dispense valves, which will be described further below. For example, the control system may use a CAN bus to carry programmed control signals for pre-determined recipe creation based on inputs provided by a user via the touch screens 110. The CAN bus may also carry signals for controlling cleaning and purging processes, as described in more detail below.

Referring to FIG. 1B, the lower cabinet 108 may include a bag-in-box (BIB) shelf 116 configured to support a plurality of BIBs 118 that may contain various liquids, such as milk, oat milk, and other liquids used for making beverages. For example, the example lower cabinet 108 may include four BIBs 118, two that contain milk, and two that contain oat milk. Each BIB 118 may be coupled to a respective pump configured to pump liquid from the BIB 118. Similarly, behind each of the upper doors 102, a BIB shelf 116 may be configured to support a plurality of BIBs 118 that may contain various liquids such as coffee, coffee concentrate, and flavorings such as caramel, vanilla, or chocolate. The upper cabinet 106 may also include a sanitizing reservoir configured to hold sanitizing solution that is used to clean components in a beverage path, as described in more detail below.

Referring now to FIG. 1C, an exploded view of an upper refrigerated cabinet according to various examples is shown, with certain components omitted for clarity. FIG. 1D shows a perspective view of an upper cabinet 106 of a beverage dispenser 100 for mixing and dispensing hot and cold beverages according to various examples, with certain components omitted for clarity. The example upper refrigerated cabinet shown in FIGS. 1C and 1D may allow for dispensing of both hot and cold beverages. According to various examples, a bottom portion of the upper cabinet 106 may be separated into a hot section and a cold section. The hot section may include a hot beverage chassis cavity 120 that may be insulated to isolate a hot beverage chassis, which allows for mixing and dispensing of liquids at least 140 degrees F, and preferably at approximately 155 degrees F. The cold section may include a cold beverage chassis cavity 122 to accommodate a cold beverage chassis, while the cold section may maintain liquids below 40 degrees F. The hot beverage chassis cavity 120 may be separated from the cold beverage chassis cavity 122 by a stepped down portion 124 of the bottom of the upper cabinet 106. The upper cabinet 106 may also include multiple pumps, such as a 3-pump assembly 126, which is configured to pump liquids from containers stored in the upper cabinet 106, as discussed further below. The upper cabinet 106 may also include a multi-tube connector 128 which may be configured to receive tubes connected to the pumps and consolidate the tubes to connect them to the beverage containers. According to one example, the multi-tube connector 128 may be a 7-tube connector that consolidates seven tubes coupled between the pumps and the beverage containers. Although not shown, the upper cabinet 106 may include a flash chiller that may maintain a layer of ice around the perimeter of a water tank through which water is circulated to keep cold water at a predetermined temperature. The flash chiller may be coupled to tubing that may be configured to provide the cold water to various components in the system. For example, as described below, a heat/cold exchanger may receive cold water from the flash chiller in order to rapidly cool warm beverages. The flash chiller may include a radiator 130 for thermal exchange. In FIG. 1D, an additional radiator 132 may also be provided in thermal communication with the beverage path.

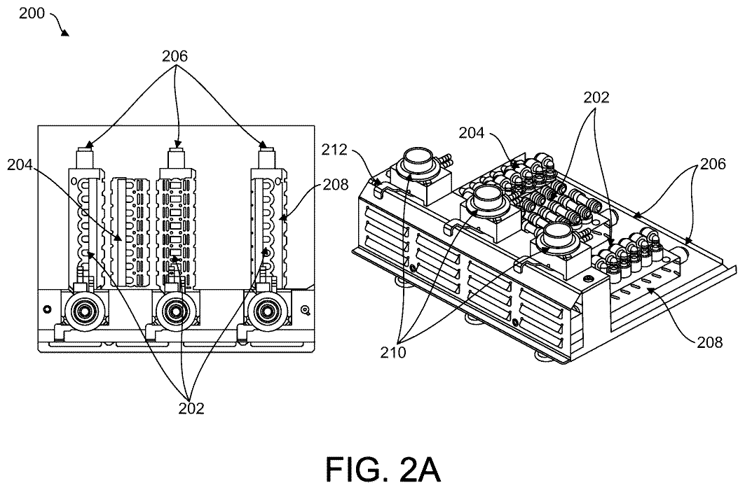

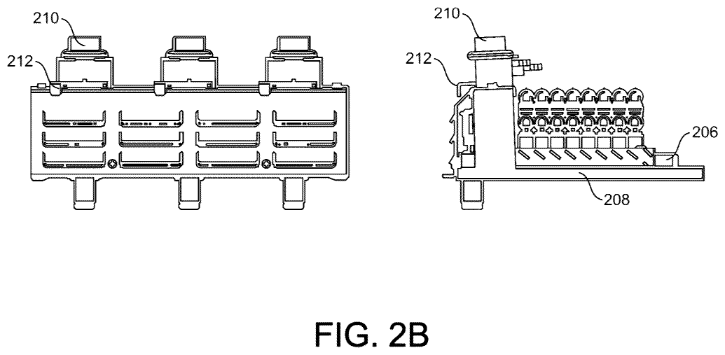

Referring to FIGS. 2A and 2B, a cold beverage chassis 200 according to various examples is shown. The cold beverage chassis 200 may be contained within the upper refrigerated cabinet shown in FIGS. 1A-1D, and more specifically in the cold beverage chassis cavity 120. The cold beverage chassis 200 may include three beverage paths, also referred to as mixing manifolds 202. These various liquids may be routed to the mixing manifolds via an input manifold 204 that is configured to receive each of the liquids from respective beverage containers. Each mixing manifold 202 may include a base liquid inlet 206 configured to receive a base liquid, such as milk, water, or oat milk, though other base liquids may be used. According to various examples, each mixing manifold may receive a different base liquid to accommodate different types of beverages that may be requested by the user. Each mixing manifold 202 may also include a plurality of additional ports that are configured to receive various liquids such as coffee and flavoring liquids such as vanilla, chocolate, and caramel. The input manifold 204 may include a plurality of input ports that are coupled to the corresponding additional ports on the mixing manifolds 202 via beverage tubes, which are omitted from FIGS. 2A and 2B for clarity. The input manifold 204 may receive multiple ingredient streams via its input ports, which may be fluidly coupled to the base liquid inlets 206 and additional ports on each mixing manifold 202. The mixing manifolds 202 may also include a gas port configured to receive a gas, such as nitrogen, and a water port that may be configured to receive water, which may be used to mix with a base beverage or other liquid received via the input manifold 204 and additional flavorings to create a beverage. The cold beverage chassis 200 may include a plurality of check ports that are configured to connect to backflush hoses or stream lines to purge or isolate ingredients during beverage preparation. The check ports may be configured to be connected to a media isolating steam valve (not shown).

Each of the mixing manifolds 202 may include a mixing chamber 208 that is configured to receive and mix the base liquid from the base liquid inlet 206 and one or more flavoring liquids and gas to generate a beverage in response to a user's request, as described in more detail below. Each mixing manifold 202 may be fluidly coupled to a respective valve assembly 210, thereby defining a dedicated beverage path from ingredient intake through dispensing. The valve assemblies 210 may be configured to output the beverage from the mixing chamber 208. The valve assemblies 210 may be coupled to respective actuators 112 that are configured to selectively actuate the valve assemblies 210 to transition between a dispense position and a sanitize positon. Each valve assembly 210 may include a valve lever 212 that may be configured to move between a dispense position and a sanitize position. When the valve lever 212 is in the dispense position, the valve assembly 210 is configured to output the beverage from the mixing chamber 208 when the actuator 112 is actuated by the user. When the lever is in the dispense position, the valve assembly 210 may be coupled to the sanitizing reservoir and may be configured to output sanitizing solution from the sanitizing reservoir via the beverage path. Tubing (not shown) may connect the sanitizing reservoir to the valve assemblies 210 for this cleaning function.

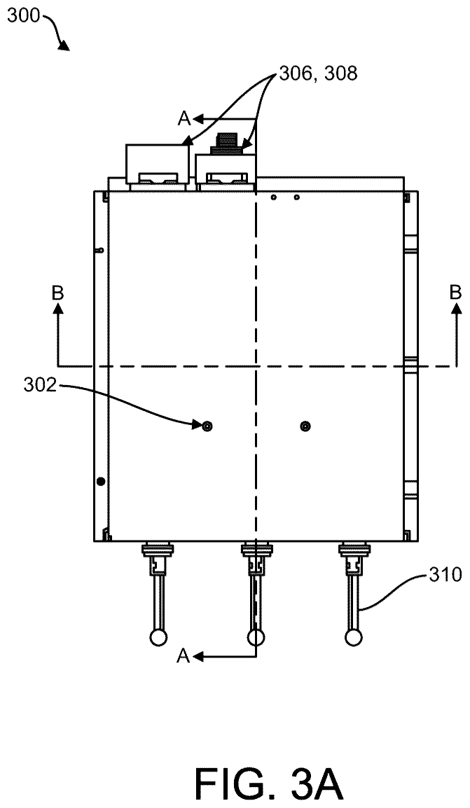

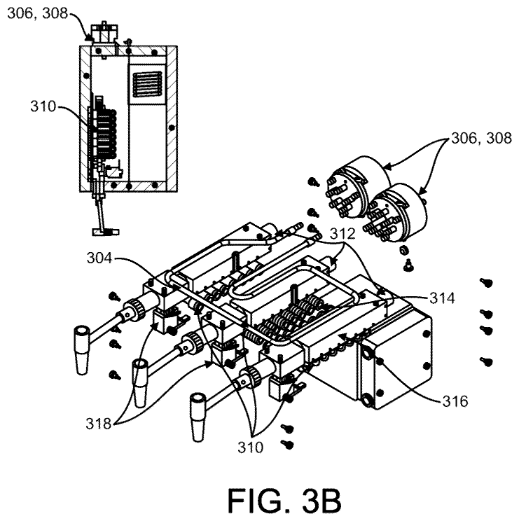

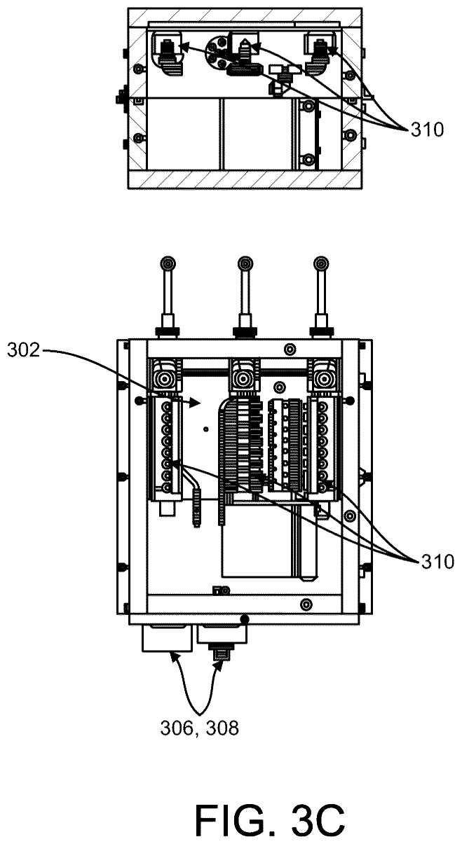

Referring to FIGS. 3A-3C, a hot beverage chassis 300 according to various examples is shown. The hot beverage chassis 300 may be similar to the cold beverage chassis 200 shown in FIGS. 2A-2B, but is inverted and may be mounted to a hot plate 302, shown in FIG. 3C, that may be made of a heat-conducting material, such as aluminum. Water for a boiler loop 304, shown in FIG. 3A, with hot plate removed for illustration, may be routed through the hot plate 302 to provide heat to the hot beverage chassis to heat the beverage to be dispensed. The hot beverage chassis 300 may be located in the hot section of the refrigerated cabinet and insulated from the cold section, as described above. The hot beverage chassis 300 may also include two bulkhead connectors 306, 308. One of the bulkhead connectors 306 may be configured to receive flavoring from an upper cabinet, such as the refrigerated cabinet shown in FIG. 1. The other bulkhead connector 308 may be configured to receive liquids such as milk and oat milk from the refrigerated cabinet of FIG. 1, as well as hot water from a boiler, which will be described below. The bulkhead connectors 306, 308 may allow the hot beverage chassis to be removed for maintenance without disconnecting many individual hoses carrying various liquids to the hot beverage chassis.

Similar to the cold beverage chassis 200 discussed above, the hot beverage chassis 300 may include a plurality of mixing manifolds 310 (e.g., three, as shown in FIGS. 3A-3C), each having a base liquid inlet 312 configured to receive a base liquid such as milk, water, or oat milk, though other base liquids may be used. According to various examples, each mixing manifold 310 may receive a different base liquid to accommodate different types of beverages that may be requested by the user. Each mixing manifold 310 may include a plurality of additional ports that may be configured to receive various liquids such as coffee and flavoring liquids such as vanilla, chocolate, and caramel, for example. These liquids may be provided to the mixing manifolds 310 by an input manifold 314 configured to receive each of the liquids from respective beverage containers. The input manifold 314 may include a plurality of ports that are fluidly coupled to the corresponding ports on the mixing manifolds 310 via beverage tubes (not shown for clarity). The mixing manifolds 310 may also include a gas port and a water port, which may be used to mix with the incoming liquids and flavorings into a beverage. Like the cold beverage chassis 200, the hot beverage chassis 300 may include check ports (not shown) that are configured to connect to one or more hoses and to back-check other ingredients during dispensing.

Each of the mixing manifolds 310 may include a mixing chamber configured to receive and mix the base liquid from the base liquid inlet 312 along with one or more flavoring liquid and gas to generate a beverage in response to a user's request. The hot beverage chassis 300 may also include a plurality of valve assemblies 318 respectively coupled to the mixing manifolds 310. The valve assemblies 318 may be configured to output the beverage from the mixing chamber 316 in response to actuation by a user. Each valve assembly 318 may include a valve lever 320 that may move between a dispense position and a sanitize position to respectively dispense beverages from the mixing chamber 316 or route sanitizing solution from the sanitizing reservoir to clean the beverage path.

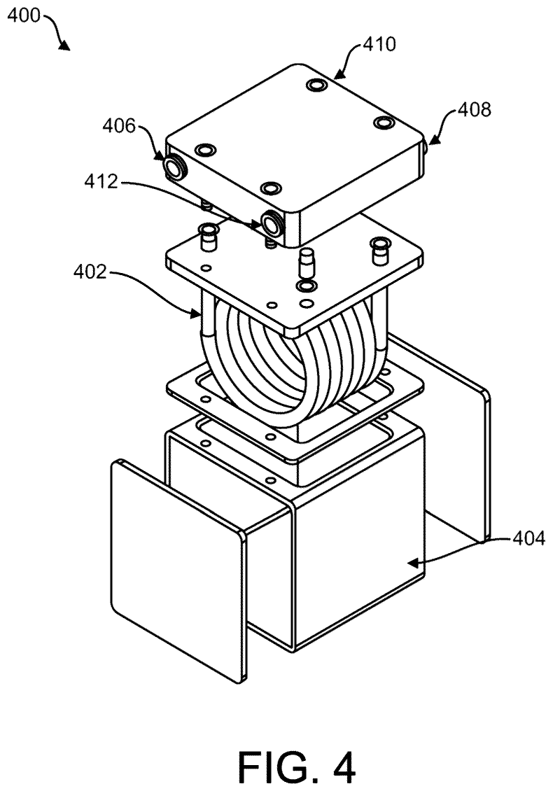

FIG. 4 shows a heat exchange module 400 according to various examples. The heat exchange module 400 may include a beverage coil 402 and a tank 404. The heat exchange module 400 may be configured to receive coffee and pre-heat the coffee for use when making espresso drinks. More specifically, the beverage coil 402 may receive a refrigerated liquid from a beverage container housed in the upper or lower cabinet, which may be input to the beverage coil 402 through a beverage input port 406. The beverage coil 402 is housed within a tank 404, which holds hot water that is received from a boiler (described below) in order to heat the beverage flowing through the beverage coil 402. The hot water from the boiler enters through a boiler input port 408, which is coupled to the tank 404 to fill it with hot water. The hot water is pumped via a pump (not shown) into the tank 404 via the boiler input port 408 and returns out through a boiler output port 410 to be circulated back to the boiler, maintaining the water temperature required to heat the beverage in the beverage coil 402 to a desired temperature. The heated beverage in the beverage coil 402 may then exit through a beverage output port 412 and be delivered to the hot beverage chassis 300 to provide a heated beverage (e.g., base liquid such as milk, water, or oat milk, flavorings, or coffee) in response to the user's selection.

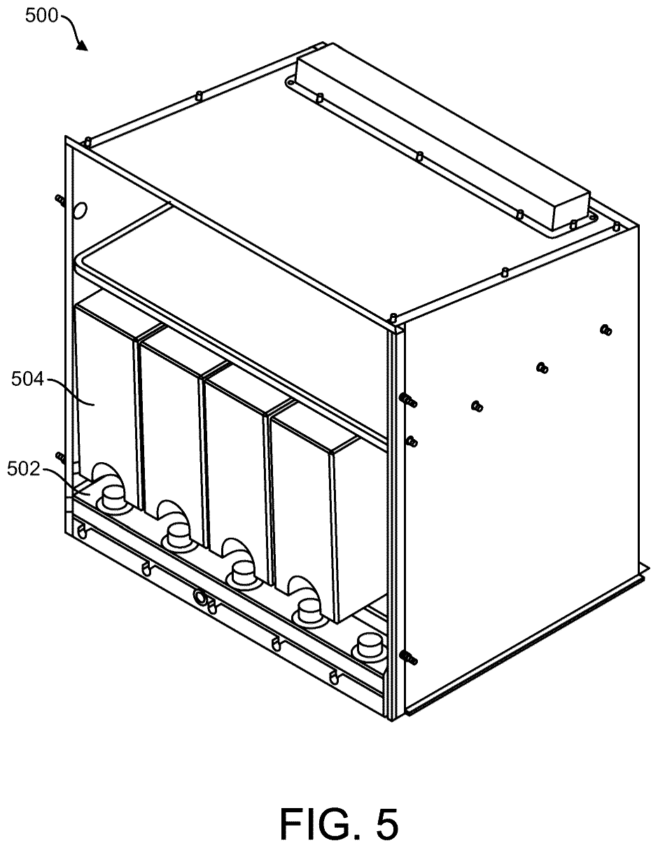

FIG. 5 shows a perspective view of a cabinet insert assembly 500 for a lower cabinet according to various examples. The cabinet insert assembly 500 may be configured to convert a commercial refrigerator into a lower dispenser cabinet. The cabinet insert assembly 500 may include a hose (not shown) that is configured to connect to an evaporator fan and a top plenum of the refrigerator that cools products and beverage path components. The cabinet insert assembly 500 may include a product bag-in-box (BIB) shelf 502 that may be configured to hold a plurality of BIBs 504 and may be angled for beverage drainage. The BIBs 504 may be configured to contain various liquids, such as milk and oat milk, to be used in generating various beverages. The cabinet insert assembly 500 may include one or more pumps that are configured to receive control signals and pump contents of the plurality of BIBs 504 in response to the control signals. The control signals may cause the pump to pump certain amounts of the contents of the plurality of BIBs 504 according to a plurality of drink recipes that may be selected by a user.

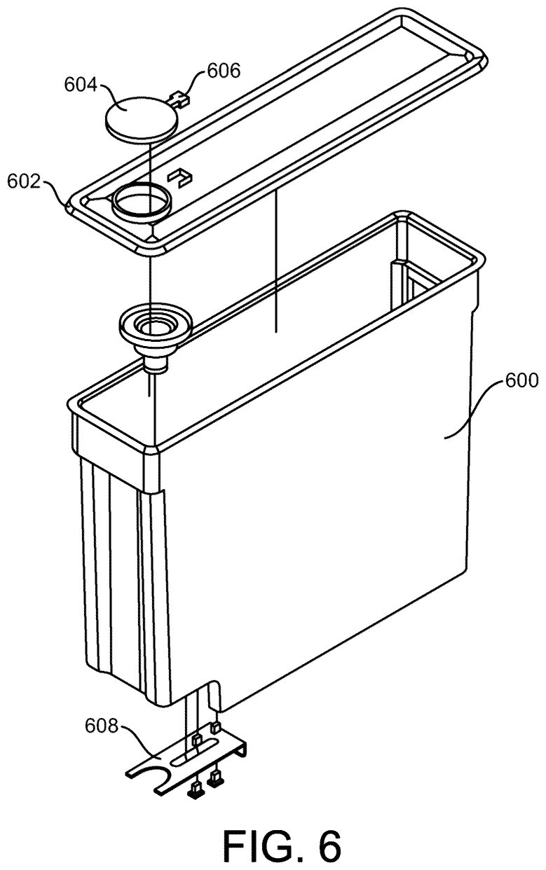

FIG. 6 shows a container 600 for holding beverage ingredients according to various examples. For example, the container 600 may be used to hold various products instead of using a BIB to hold beverage ingredients. For example, the container 600 may be used for milk and syrups that are used to make a variety of beverages. The container 600 may include a lid 602 having an opening to receive beverage ingredients. The lid 602 may include a cover 604 that is hingedly affixed via a hinge 606 in order to allow the cover 604 to seal the opening when in a closed position, and allow beverage ingredients to be poured into the opening when the cover is in an open position. The container 600 may also include a latch 608 at a bottom side of the container, which is configured to engage a Scholle fitment.

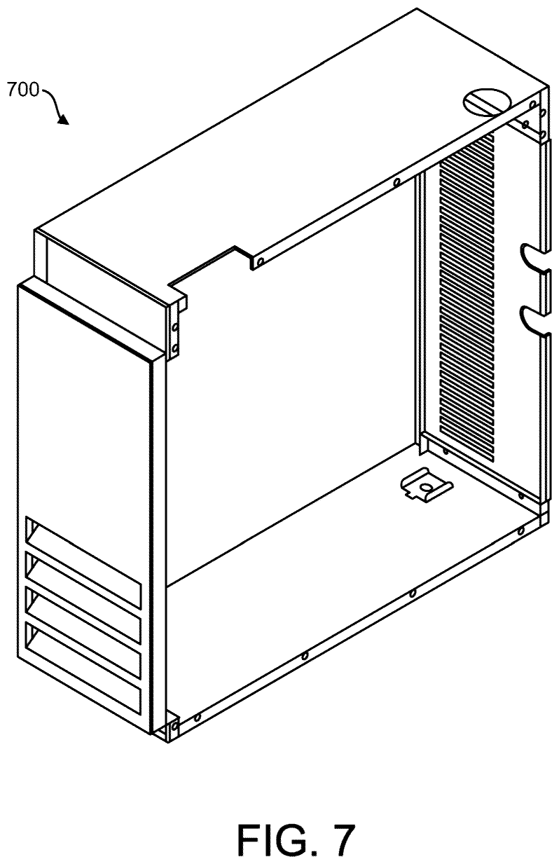

FIG. 7 shows a component cabinet 700 to be attached to or inserted into a commercial refrigerator according to various examples. The component cabinet 700 may be used in conjunction with casters, rails, and other types of coupling mechanisms to secure the component cabinet 700 below a countertop and within or adjacent to a commercial refrigerator to convert the refrigerator to a beverage dispenser according to various examples. The component cabinet 700 may be sized and shaped to accommodate additional components that may be added to the beverage dispenser. For example, the component cabinet 700 may be sized and shaped to accommodate one or more heat exchange modules, such as the example heat exchange module 400 of FIG. 4, in order to heat various liquids to be used in generating a beverage.

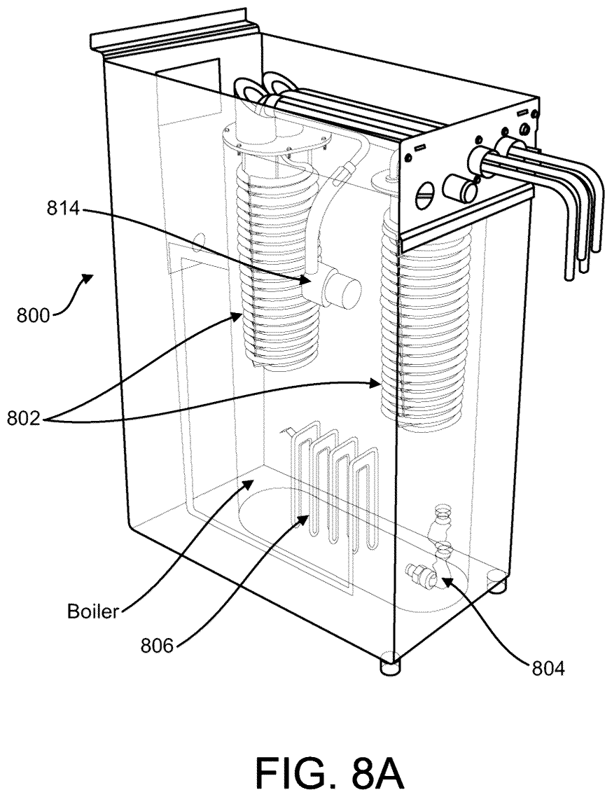

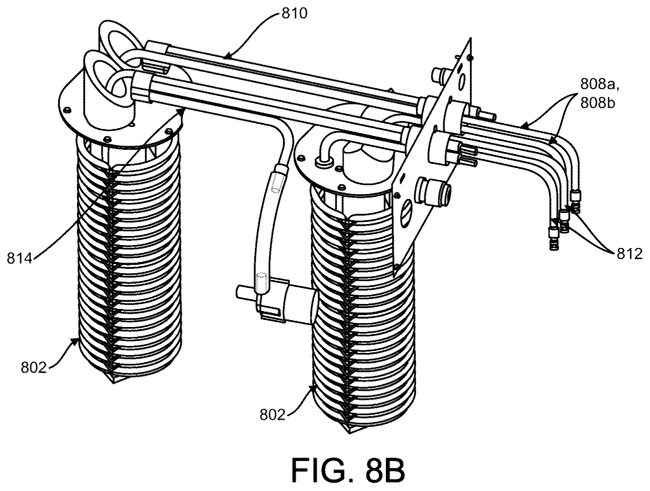

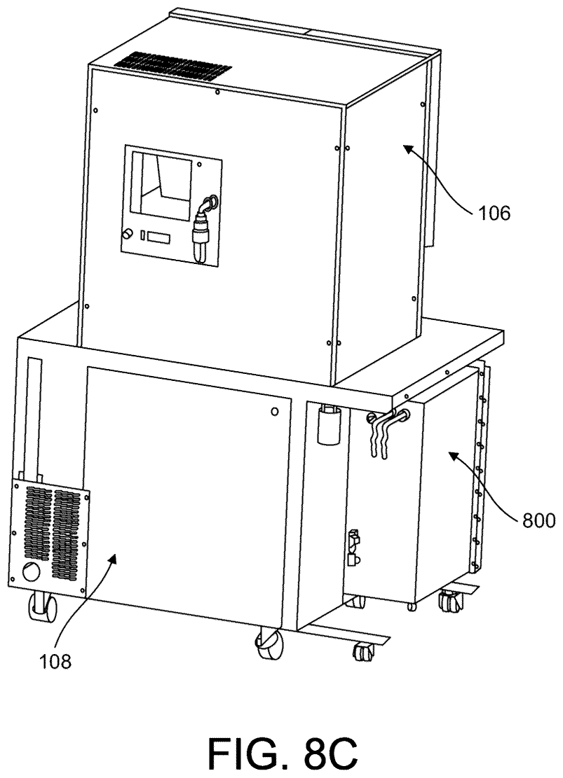

FIG. 8A shows a perspective view of a flash heater 800 according to various examples, and FIG. 8B shows an enlarged view of certain components of the flash heater 800. The flash heater 800 may include a water tank and multiple beverage coils 802, which may be made of stainless steel, though other materials may be used. The flash heater 800 may include a water inlet 804 that is configured to receive water (such as tap water) to fill the water tank. The water tank may also include a radiator 806 that is used to heat the water in the tank. According to various examples, the water tank is filled so that the water level substantially submerges the beverage coils 802.

Referring to FIG. 8B, the flash heater 800 may include two cold beverage inputs 808a, 808b that are respectively configured to receive refrigerated liquids such as milk, oat milk, flavorings, or coffee, and provide the refrigerated liquids to the respective beverage coils 802. As shown in FIG. 8B, one cold beverage input 808a provides a refrigerated liquid to the beverage coil on the left, and the other cold beverage input 808b provides another refrigerated liquid to the beverage coil on the left. The cold beverage input line 808a providing refrigerated liquid to the left beverage coil 802 may be coupled to a cold water loop 810 that may receive cold water from a flash chiller that may be disposed in the upper refrigerated cabinet. The cold water loop 810 may keep the refrigerated liquid at an acceptably cold temperature (e.g., below 40 degrees F) as the beverage travels from the cold beverage input 808a to the beverage coil 802.

When the refrigerated beverages enter the respective beverage coils 802, they travel down to the bottom of the coil and then back up to be output via the hot beverage output lines 812. The length of the beverage coils 802 may be selected such that the dwell time is sufficient to heat a refrigerated beverage from a predetermined cold temperature (e.g., 40 degrees F) to a target hot temperature (e.g., 155 degrees F). For example, the length may support continuous flow: as long as refrigerated liquid is supplied, hot liquid may be continuously dispensed at a stable output temperature. The flash heater 800 may also include a boiler pump 814 and a hot water loop 816 configured to circulate hot water from the tank through the loop and back to the tank to maintain temperature. The hot water loop 816 may be thermally coupled to the hot beverage output lines 812 to preserve output temperature. The flash heater 800 may include a flange mount module (not shown) for securing to the component cabinet 700 of FIG. 7. According to various examples, the flash heater 800 may be mounted in the lower cabinet 120 using one or more rails supported by a plurality of casters, as shown in FIG. 8C.

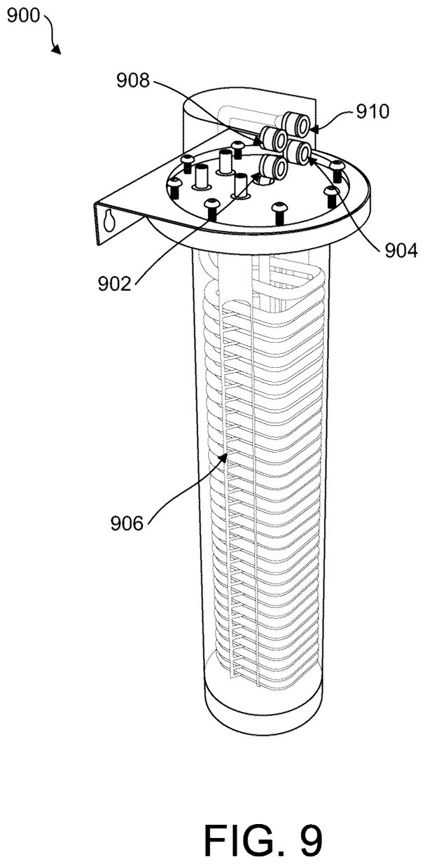

FIG. 9 shows a beverage heat/cold exchanger 900 according to various examples. As explained above, beverage coils in a boiler may heat various liquids such as water, flavorings, and milk, and the heat/cold exchanger 900 may be used to heat additional liquids, such as oat milk. The flash heater 800 of FIGS. 8A-8B may maintain a tap water level that is heated to warm liquid in its beverage coils, and provide a loop of hot water. The heat/cold exchanger 900 may similarly include a water input port 902 and a water output port 904 to respectively input and output water into a container that houses a beverage coil 906. A beverage input port 908 is configured to receive a beverage and is coupled to the beverage coil 906 to allow the beverage to flow down to the bottom of the beverage coil 906 and back up to the top, where the beverage is output via a beverage output port 910.

The beverage input to the heat/cold exchanger 900 may be refrigerated, and if hot water is received at the water input port 902, the heat/cold exchanger 900 will output a hot beverage through the beverage output port 910. Alternatively, if the heat/cold exchanger 900 receives a hot beverage and cold water (e.g., from a flash chiller) at the water input port 902, it will output a cooled beverage. The beverage output port 910 may be coupled to either the hot beverage chassis or the cold beverage chassis depending on the target output temperature.

Referring again to FIG. 1A, the touch screens 110 may be configured to display a user interface that allows a user to select from a variety of beverages. The control system of the beverage dispenser 100 may include a memory unit, such as a read-only memory (ROM), electrically erasable programmable ROM (EEPROM), random access memory (RAM), flash memory, and other suitable memory devices to store information relating recipes for different types of beverages. For example, for a vanilla latte beverage, the memory unit may store information relating to the amount coffee, water, milk, and vanilla flavoring needed for a vanilla latte of a particular size. Upon selection of a particular beverage by the user, one or more signals may be transmitted to retrieve information relating to the user's selection from the memory unit, and the processing circuitry of the control system may control the hot and cold beverage chassis 300, 200 to output corresponding amounts of the constituent ingredients to make the selected beverage. When the beverage is prepared and ready to be dispensed, the user interface displayed on the touch screen 110 may indicate that the beverage is ready to be dispensed, and may indicate which actuator 112 the user should use to dispense the beverage from the nozzle 114. For example, if the selected beverage requires an oat milk base, the actuator 112 corresponding to the mixing manifold 202 that receives oat milk as its base liquid may be indicated by displaying a green light on the user interface above the actuator 112. When the actuator 112 is actuated by the user, the prepared beverage is output from the nozzle 114.

The user interface may also allow the user make modifications to beverages whose recipes are stored in the memory unit. For example, if a user selects a vanilla latte from the user interface, the user may also select the option of adding caramel flavoring. In this example, the processing circuitry is configured to determine how much caramel flavoring is to be added, and may reduce the amount of other ingredients needed to make a vanilla latte to accommodate the beverage size selected by the user. For example, if a user selects a 12 oz. vanilla latte, the recipe for a vanilla latte will contain amounts of ingredients needed to output a 12 oz. vanilla latte. But adding caramel flavoring may cause the beverage to overflow a 12 oz. cup, so the control system may be configured to determine an amount by which to reduce the amount of ingredients, such as milk or vanilla flavoring needed to accommodate the user's request for additional caramel flavoring without causing overflow. Similarly, the control system may be configured to determine the amount of each ingredient needed depending on whether the user has selected a beverage to be poured over ice. For example, a 12 oz. beverage poured into a cup with no ice would overflow if poured into the same size cup that is half filled with ice. The user interface may enable to user to select whether the user intends to pour the selected beverage into a cup with or without ice, and indicate the size of the cup. Based on the user's selection, the control system may determine the amount of each ingredient needed to generate the user's selected beverage. The control system may also be able to adjust the amount of each ingredient according to additional parameters, not just in order to avoid overflow. For example, if the user's selection of ingredients would change the viscosity of the beverage outside of a predetermined range, the control system may adjust other ingredients of the beverage in order to achieve a beverage with a viscosity in the predetermined range. The control system may also adjust ingredients based on other parameters such as coffee strength, amount of sugar, or the avoidance of allergens such as dairy, for example.

The control system may also be configured to control a gas regulator to control the amount of gas to be infused into a beverage according to the user's selection. For example, if the user selects a nitrogen infused coffee beverage, the control system may be configured to control the gas regulator to provide a suitable amount of gas to the hot or cold beverage chassis 300, 200 to infuse the beverage with nitrogen gas. The system may use ambient air (which is primarily nitrogen), or may use separate gas containers to provide gas for infusing into beverages.

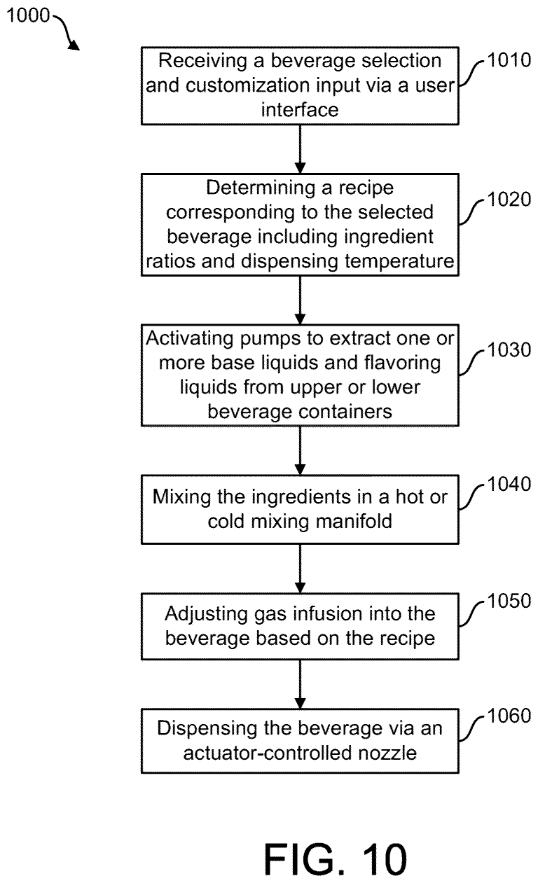

FIG. 10 shows a flowchart of a method 1000 for dispensing a customized beverage using a beverage dispenser according to various examples. The method 1000 may be performed using the beverage dispensing system described in connection with FIG. 1-9.

The method 1000 may begin at step 1010, which includes receiving a beverage selection and customization input via a user interface. The customization input may include a beverage type, optional ingredients such as flavoring or non-dairy milk, cup size, or serving over ice.

At step 1020, the method 1000 may include determining a recipe corresponding to the selected beverage, including ingredient ratios and a target dispensing temperature. The recipe may be retrieved from memory and adjusted dynamically based on the user's selections.

At step 1030, the method 1000 may include activating pumps to extract one or more base liquids and flavoring liquids from containers located in upper or lower compartments of the system.

At step 1040, the method 1000 may include mixing the extracted ingredients in a hot or cold mixing manifold, depending on the temperature profile specified in the recipe.

At step 1050, the method 1000 may include adjusting gas infusion into the beverage in accordance with the recipe. This may involve activating a gas regulator to infuse nitrogen or another gas into the beverage mixture.

At step 1060, the method 1000 may conclude with dispensing the beverage via an actuator-controlled nozzle when the user actuates a corresponding interface or mechanical actuator.

Various examples have been disclosed herein, in connection with the above description and the drawings. It will be understood that it would be unduly repetitious to literally describe and illustrate every combination and subcombination of these examples. Accordingly, all examples can be combined in any way and/or combination, and the present specification, including the drawings, shall be construed to constitute a complete written description of all combinations and subcombinations of the examples described herein, and of the manner and process of making and using them, and shall support claims to any such combination or subcombination.

It will be appreciated by persons skilled in the art that the examples described herein are not limited to what has been particularly shown and described herein above. In addition, unless mention was made above to the contrary, it should be noted that all of the accompanying drawings are not to scale. A variety of modifications and variations are possible in light of the above teachings.

What is claimed is:

1. A beverage dispensing unit comprising:
an upper cabinet configured to house a first plurality of beverage containers, a cold beverage chassis, a hot beverage chassis, and one or more user interfaces configured to receive a beverage request from a user;
a lower cabinet configured to house a second plurality of beverage containers;
a flash heater including a boiler configured to heat water and one or more beverage coils configured to be submerged in the hot water to heat one or more beverages respectively disposed in the beverage coils;
a cold exchange unit containing a water tank and a second beverage coil contained within the water tank to chill a beverage contained with the beverage coil; and
a flash chiller configured to chill water and circulate cold water to the cold exchange unit to fill the water tank;
wherein the hot and cold beverage chassis are configured to receive and mix one or more base liquids, a plurality of flavor liquids, and a gas based on the beverage request from the user.

2. The beverage dispensing unit of claim 1, wherein the upper cabinet further comprises refrigerated compartments separated into hot and cold chassis cavities.

3. The beverage dispensing unit of claim 1, wherein the lower cabinet comprises a bag-in-box (BIB) shelf configured to store milk, oat milk, and other liquid ingredients.

4. The beverage dispensing unit of claim 1, wherein the cold beverage chassis comprises three mixing manifolds each configured to receive distinct liquid bases.

5. The beverage dispensing unit of claim 4, wherein each mixing manifold includes at least one port for receiving a gas and another port for receiving water.

6. The beverage dispensing unit of claim 1, wherein each actuator is coupled to a dispense valve having a sanitize position and a dispense position.

7. The beverage dispensing unit of claim 1, wherein the beverage coils in the flash heater are formed from stainless steel.

8. The beverage dispensing unit of claim 1, wherein the beverage output temperature is controlled by varying the length and material of the beverage coils in the flash heater and exchanger modules.

9. The beverage dispensing unit of claim 1, further comprising a multi-tube connector in the upper cabinet configured to consolidate beverage tubes from pumps to ingredient containers.

10. A beverage dispensing system comprising:
a control system coupled to a plurality of actuators, a memory storing beverage recipes, and a plurality of temperature control modules including a flash heater and a flash chiller;
wherein the control system is configured to receive a user beverage request via a touch screen, determine a recipe based on the request, and control the dispensing of beverage ingredients via a hot or cold chassis accordingly;
wherein the hot chassis and cold chassis each comprise multiple mixing manifolds, each configured to mix a base liquid, one or more flavoring liquids, and a gas to form a beverage.

11. The beverage dispensing system of claim 10, wherein the control system includes a CAN bus configured to carry pre-programmed control signals for recipe creation and cleaning sequences.

12. The beverage dispensing system of claim 10, wherein the memory comprises recipes that are dynamically adjusted based on selected cup size and whether the beverage is to be served over ice.

13. The beverage dispensing system of claim 10, wherein the beverage chassis are removable via bulkhead connectors for service without detaching individual ingredient tubes.

14. The beverage dispensing system of claim 10, wherein the flash heater maintains a water level sufficient to submerge beverage coils and provide continuous hot beverage output.

15. The beverage dispensing system of claim 10, wherein the flash chiller maintains a layer of ice around a cold water tank to stabilize the temperature of beverages during dispensing.

16. A method of dispensing a customized beverage using a beverage dispenser, the method comprising:
receiving a beverage selection and customization input via a user interface;
determining a recipe corresponding to the selected beverage including ingredient ratios and dispensing temperature;
activating pumps to extract one or more base liquids and flavoring liquids from upper or lower beverage containers;
mixing the ingredients in a hot or cold mixing manifold;
adjusting gas infusion into the beverage based on the recipe; and
dispensing the beverage via an actuator-controlled nozzle.

17. The method of claim 16, wherein adjusting gas infusion comprises regulating nitrogen infusion for cold brew coffee or other carbonated beverages.

18. The method of claim 16, further comprising sanitizing the beverage path by actuating a sanitize mode or the dispensing valves to flow sanitizing solution through the manifolds.

19. The method of claim 16, wherein the determining step further comprises reducing amounts of other ingredients in response to a customization request for additional flavoring to avoid overflow.

20. The method of claim 16, wherein the user interface presents a visual indicator above the actuator corresponding to the ready-to-dispense beverage.
